(19) United States
(12) Patent Application Publication
(10) Pub. No.: US 2024/0256776 A1
(43) Pub. Date: Aug. 1, 2024

(54) EXTRACTION OF ANNOTATIONS FROM FREE TEXT USING TRIES

(71) Applicant: ILLUMINA, Inc., San Diego, CA (US)

(72) Inventors: Max Joseph Arseneault, Redondo Beach, CA (US); Andrew Robert Warren, Carlsbad, CA (US)

(21) Appl. No.: 18/104,031

(22) Filed: Jan. 31, 2023

(51) Int. Cl. G06F 40/289; G06F 16/901; G06F 16/903

(52) U.S. Cl. CPC G06F 40/289; G06F 16/9024; G06F 16/9027; G06F 16/90344

(57) ABSTRACT

Techniques are described for processing a text document or passage to derive a suitable set of phrases from the document or passage. These phrases may in turn be related to codes or other labels useful to a reviewer, such as insurance, diagnostic, or clinical codes, genes related to identified phenotypes, and so forth. In certain embodiments, one or more tries generated based on respective ontologies may be used to process and parse the input text passage or document to derive candidate phrases. To improve performance, a limited number of skips may be allowed. The candidate phrases and corresponding intervals may, in one implementation, be used to populate a graph having nodes and edges and from which a set of phrases may be determined that provides maximal coverage of the text passage or document and having limited (or no) overlaps.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

In various contexts, a text-based passage (e.g., text string) or document comprising such passages may be processed, such as using natural language processing (NLP) techniques, to derive useful information from the text. Information derived in this manner may be subsequently used in digitally-implemented processes or to drive conversation-trees or decision-trees based on the content of the passage or document. As used herein, NLP may be understood to correspond to a general area of computer science, which may include machine learning (ML) or artificial intelligence (AI) aspects, that involves some form of processing of natural language input. Examples of areas addressed by NLP may include language translation, speech or text generation, parse tree extraction, part-of-speech identification, and others. NLP is generally used to interpret free text for further analysis and/or downstream processing. Such approaches may be used in contexts where free text or other non-constrained text-based passages are provided and where information or content derived from such free-text passages is needed to inform downstream process or decisions, such as to access or provide useful information to a decision maker.

Certain such NLP concepts may be employed in the biomedical space to facilitate the automated extraction of annotations of biomedical terms or concepts from free text data. By way of context, such annotations may correspond to phenotypes to symptom descriptions, patient descriptors or characteristics, diagnoses, genes or mutations, and so forth. Such annotations, when derived in this context may be useful for linking to clinical or insurance codes (e.g., standardized codes or nomenclature) which may be useful in an electronic medical record context, a diagnostic or research context, a treatment context, a billing context, a longitudinal study context, and so forth. Further, such approaches may be useful to allow linkage or cross-reference between different medical ontologies or nomenclatures and/or to allow annotations derived from such free-text to be linked to or associated with different and distinct medical ontologies.

In practice, however, such techniques may be difficult to effectively implement. By way of example, the text in question may be, or be derived from, clinical notes or other informal notes or text content. Such notes may be dictated and/or consist of notes taken by a medical professional in an examination room or other patient contact. In practice, such notes may be unstructured, may have confusing or limited punctuation (e.g., lack of commas or periods, no capitalization, and so forth), may be grammatically incomplete or inconsistent, may consist of incomplete sentences or thoughts (e.g., may be a simple listing of observations, without conventional noun-verb-object type structure), may include abbreviations and mis-spelled words, and so forth. Correspondingly conventional NLP approaches (including those involving artificial intelligence (AI) components) may perform poorly in the context of extracting annotations of biomedical terminology or concepts from such free-text source materials.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

As discussed herein, techniques are provided for processing a grammar-poor text document or passage to derive a suitable set of phrases from the document or passage. These phrases may in turn be related to codes, names, descriptors, or other labels useful to a reader or reviewer, such as insurance, diagnostic or clinical codes, or genes related to identified phenotypes in a biomedical context or names, items, tasks, addresses, and so forth in a non-biomedical context. Though certain examples discussed herein are provided in a biomedical or genetic context, it should be appreciated that the disclosed techniques may be useful in any context in which punctuation or grammar within a text input is limited, including any spoken language contexts in which the transcribed text used for processing is deficient in grammar or punctuation. By way of example, other contexts in which the present techniques may be employed include, but are not limited to, communications with a virtual assistance device, such as for communicating grocery or shopping lists, tasks or to-do lists, lists of contact names for a text message or e-mail, and so forth.

In the presently disclosed example, one or more tries generated based on respective ontologies may be used to process and parse the input text passage or document to derive candidate phrases (e.g., noun phrases). To improve performance, a limited (e.g., 1, 2, 3, 4, 5, or more) number of “skips” may be allowed so as to prevent or limit falling off the trie due to the presence of one or more extraneous words. Each phrase so identified has a corresponding interval. The candidate phrases and corresponding intervals are used to populate a graph in which phrases (and corresponding intervals) are depicted as nodes and in which edges connect non-overlapping nodes. A clique may then be determined corresponding to minimized or otherwise limited (e.g., 0) overlaps and maximal coverage of the passage or document. The nodes of the clique correspond to a set of phrases providing maximal coverage of the text passage or document and having minimized (or no) overlaps. This set of phrases may then be linked to or associated with the codes of interest to a reviewer.

With this in mind, in one embodiment, the present disclosure provides a method for processing a text input (which may be provided initially as text or as a transcription of an initial verbal or spoken communication). In accordance with this embodiment, a text string comprising a plurality of discrete words is received as an input. The text string is processed using a trie corresponding to one or more ontologies of interest. A number of skips are defined for processing the trie so that deviations of the words within the text string up to the number of skips are allowed during processing. An output of processing the text string using the trie comprises a plurality of phrases. The output is processed to determine a set of phrases that both minimize (or otherwise limit) a number of overlaps (e.g., 0 overlaps) between the phrases and maximize coverage of the text string. Each phrase of the set of phrases is associated with a respective ontology code. The respective ontology codes are output for review.

In a further embodiment, one or more tangible, machine-readable media storing processor-executable routines are provided. The processor-executable routines, when executed by a processor, cause acts to be performed comprising: processing a text string using a trie, wherein a number of skips are defined for processing the trie so that deviations within the text string relative to the trie up to the number of skips are allowed without falling off the trie, wherein an output of processing the text string using the trie comprises a plurality of phrases each having a respective interval. The processor-executable routines, when executed by the processor, cause further acts to be performed comprising: generating a graph based on the output, wherein the graph comprises: a respective node for each phrase and associated interval; a respective edge between each pair of non-intersecting nodes. The processor-executable routines, when executed by the processor, cause further acts to be performed comprising: determining a clique providing maximal coverage of the text string based on the graph and determining or outputting one or more phrases corresponding to the clique as parsed phrases for the text string.

In an additional embodiment, a method is provided for selecting a subset of phrases from among a plurality of phrases. In accordance with this embodiment, a graph is generated that comprises: a respective node for each phrase of the plurality of phrases, wherein each node has a corresponding interval based on the phrase corresponding to the respective node; a respective edge between each pair of non-intersecting nodes; and one or more cliques, wherein each clique corresponds to one or more inter-connected and non-overlapping nodes. A respective clique of the one or more cliques is determined that provides maximal coverage of a text string comprising the plurality of phrases. A respective code corresponding to each node of the respective clique is output. Each node of the respective clique is associated with a respective phrase of the plurality of phrases.

The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown, but is to be accorded the widest scope consistent with the principles and features disclosed herein. The scope of the technology disclosed is defined by the appended claims.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts a schematic diagram of an annotation extraction system implementation in a networked or cloud computing environment, in accordance with aspects of the present technique;

FIG. 2 is a simplified block diagram of a processor-based system, in accordance with aspects of the present technique;

FIG. 3 schematically depicts a trie-based approach for processing a text string, in accordance with aspects of the present technique;

FIG. 4 schematically depicts a further example of a trie-based approach for processing a text string, in accordance with aspects of the present technique;

FIG. 5 schematically depicts a technique for processing conjunctions using a trie-based approach for processing a text string, in accordance with aspects of the present technique;

FIG. 6 depicts a process flow for processing a set of phrases to derive a subset of non-overlapping phrases, in accordance with aspects of the present technique;

FIG. 7 depicts a further example of a process flow for processing a set of phrases to derive a subset of non-overlapping phrases, in accordance with aspects of the present technique;

FIG. 8 depicts a process flow for processing an initial document to generate an annotated document, in accordance with aspects of the present technique; and

FIG. 9 depicts a sub-flow of the process flow of FIG. 8 depicting steps of trie-based processing and interval determination, in accordance with aspects of the present technique.

### DETAILED DESCRIPTION

The following discussion is presented to enable any person skilled in the art to make and use the technology disclosed, and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown, but is to be accorded the widest scope consistent with the principles and features disclosed herein.

As discussed herein, techniques are described that may be employed for processing free text data, including text data that is grammar-poor (such as text data derived from dictation or informal note taking and in which commas, periods, or grammar may be absent, poorly implemented, or poorly conveyed). As used herein, “grammar-poor” may be understood to correspond to a text or text string comprising incomplete or run-on sentences, including text strings in which noun phrases are strung together without separating or phrase delineating punctuation or in which conventional rules of grammar or punctuation are not adhered to. Such processing may allow identification or derivation of annotations from the processed text which may be useful in relating the content of the text to one or more ontological models and/or to associate the derived annotations with codes or labels that may be employed in downstream processes or analysis. In this manner, a grammar-poor and/or unstructured text passage may be processed to derive annotations that may be useful in analyzing or organizing the data.

To facilitate explanation and to provide a real-world context for these techniques, certain illustrative examples are provided, such as examples in the biomedical space as well as examples in the context of informal lists or communications in the non-biomedical space. For instance, one such example may involve the processing of free-text notes (e.g., informal or “jotted down” notes) or transcribed text derived from dictation or other spoken communications. In certain such biomedical examples the medical professional, in the course of examining or treating a patient, may take notes related to their observations and/or assessment of the patient. Such notes may be taken in an examination room or other clinical setting and may involve the clinician dictating their notes or writing the notes in a relatively informal manner (e.g., jotting down handwritten notes, or typing notes in a quick and abbreviated manner). Such notes may be free-text (e.g., not limited to set or defined text options within designated fields or spaces), may be stream of thought or consciousness, and may be poorly punctuated or otherwise grammar-poor (such as not having appropriate commas, periods, or capitalization). Further, such notes may not be organized in conventional sentences or paragraphs, instead comprising listing of observations or symptoms, including acronyms and/or abbreviated descriptions or lingo specific to the clinician or their institution. Similarly, in non-biomedical contexts informal notes or text may be generated corresponding to a shopping list, list of contacts, tasks or to-do items to be performed, and so forth. As with the biomedical examples, such lists or notes may have little to no punctuation, may contain mis-spellings, acronyms, or abbreviations, may be informally organized, and/or may be derived (e.g., transcribed) from spoken communications, such as spoken instructions to a virtual assistant. Correspondingly, it may be difficult for conventional natural language processing (NLP) techniques (which may be trained to process structured text fields or data and/or to process complete sentences having appropriate punctuation) to meaningfully analyze such free text materials. In particular, in the context of free-text processing (including transcribed and/or grammar-poor contexts) conventional AI-based approaches may perform poorly in terms of faulty or erroneous AI annotation, no or incomplete linkage to specific medical ontologies of interest, overlap of annotations (e.g., phenotypes), lack of customizability, lack of gene annotation, failure to identify or translate abbreviations, non-orthogonal annotation, and so forth.

As discussed herein, the present techniques improve the extraction of annotations (e.g., phenotype annotations) from free-text source materials, including grammar-poor source materials (e.g., transcribed notes or text, clinical interview or observation notes, and so forth). In particular, the presently disclosed techniques address the identification of phenotypes (or other suitable labels or annotations) in free-text as well as the resolution of overlapping phenotypes that may be derived or identified in such materials as part of the identification process. In addition, the presently disclosed techniques may allow for the inclusion or selection of only the desired ontologies (e.g., MONDO, HPO, OMIM, MeSH, and so forth) and/or the exclusion of undesired ontological terms as well as the annotation of genes (e.g., NCBI and/or HGNC genes).

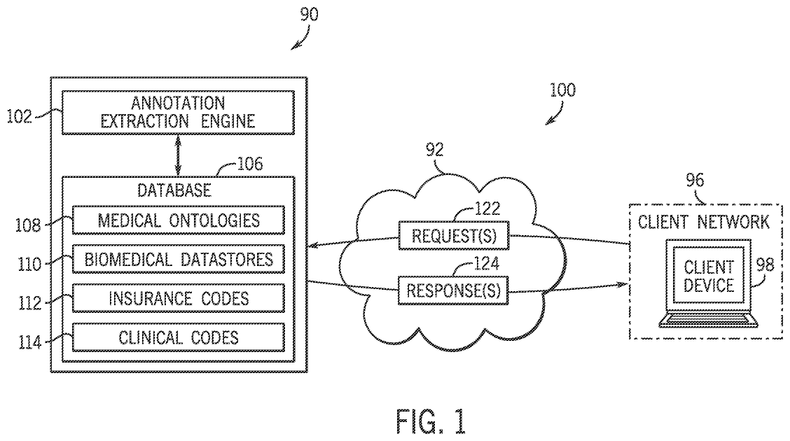

With the preceding in mind, FIG. 1 illustrates a schematic view of a cloud- or network-based annotation extraction framework. In particular, FIG. 1 depicts aspects of a cloud- or network-based approach by which a text-based document or passage submitted at a local resource (e.g., a workstation or thin-client) may be analyzed to extract annotations using resources provided by a remote environment (e.g., a remote or online server or datacenter). In such a context, all or part of the analysis may occur remotely or, alternatively, the analysis may be performed using both local and remote resources. For example, certain aspects of the processes described herein may be performed at the datacenter or remote server, while other aspects of the processed may be performed locally at the workstation or thin-client. Further, though a cloud- or network-based approach is described with respect to FIG. 1 so as to provide a comprehensive example, in practice the processes and techniques described herein may be performed on a single processor-based device, either with or without a network connection. Thus, the example described with respect to FIG. 1 should be understood to not be limiting, but instead to provide context for one type of real-world implementation.

With this in mind, and turning to FIG. 1, an annotation extraction framework 100 is depicted in accordance with embodiments of the present technique. More specifically, FIG. 1 illustrates an abstraction of a cloud platform infrastructure and local client interface to the cloud infrastructure, such as via a local network. In this example, a cloud-based platform 90 (such as may be instantiated at a datacenter or a remote server) is connected to a client device 98 via a network 92 to facilitate processing of a text document or passage as discussed herein. Such a connection may be implemented via a web browser interface, a dedicated, standalone application, or other suitable program or data interfaces. In the depicted example, the client device 98 is itself part of or in communication with a local client network 96 that is configured to communicate with the network 92 that allows communication outside the client network 96. As used herein, a server, workstation, or other processor-based device may be understood to be implemented as a virtual instance (e.g., a virtual server) or as a physical or hardware implementation, though it should be understood that virtual servers also have underlying physical memory and processor aspects.

The implementation of the annotation extraction framework 100 illustrated in FIG. 1 includes an annotation extraction engine 102 configured to implement the logic and processes described herein and one or more databases 106 (either within a client instance, within the cloud-based platform 90 (e.g., within the datacenter or a related datacenter), or otherwise accessible by the instance and/or platform 90). The annotation extraction engine 102 may interact with a user of the client device 98 via requests 122 (e.g., submissions of free-text passages or documents) and responses 124 (e.g., annotations and/or data linked to the extracted annotations, such as insurance codes, diagnostic or clinical codes, diagnoses, and so forth).

For the embodiment illustrated in FIG. 1, the database 106 may be database, a database server instance, or a collection of database server instances. The illustrated database 106 may store or access one or more medical ontologies 108 (e.g., MONDO, HPO, OMIM, MeSH, and so forth), one or more biomedical and/or genetic datastores 110 (e.g., NCBI, HGNC, and so forth), one or more insurance code schemas 112, and/or one or more diagnostic or clinical code schemas 114. As discussed herein, annotations derived for a text passage or document (provided via request 122) via the annotation extraction engine 102 may be used in conjunction with the data present in the database(s) to formulate a responsive reply 124 to the user of the client device 98. As may be appreciated, though the presently depicted example pertains to a biomedical context, in other contexts the data and ontologies referenced may not be biomedical in nature, but instead may be selected based on a suitable context. For example, in a virtual assistant context the data and ontologies referenced may relate to store catalogs or inventories, contact lists, manufacturer product lists, and so forth.

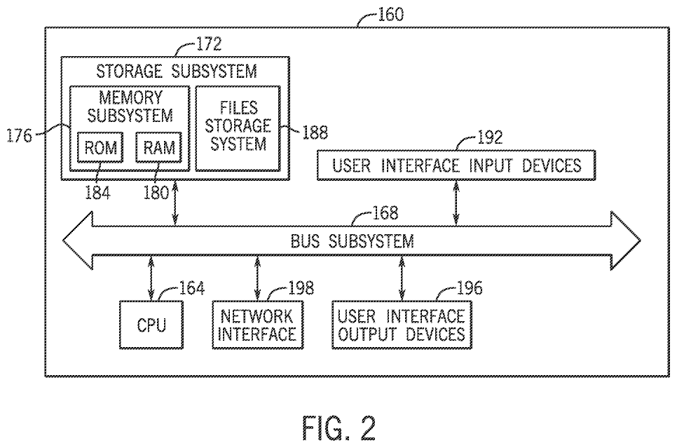

With the preceding in mind, FIG. 2 depicts an example of a processor-based system 160 (e.g., a workstation, a server, a thin client, a computer system, and so forth) suitable for use as the client device(s) 98 or as part of the cloud-based platform 90 in accordance with the framework illustrated in FIG. 1. In this example system, a high-level hardware architecture is described for reference. Such hardware may be physically embodied as one or more computer systems (e.g., servers, workstations, and so forth). It should be appreciated that the present example may include components not found in all embodiments of such a system or may not illustrate all components that may be found in such a system. Further, in practice aspects of the present approach may be implemented in part or entirely in a virtual server or client environment or as part of a cloud platform. However, in such contexts the various virtual server or client instantiations will still be implemented on an underlying hardware platform as described with respect to FIG. 2, although certain functional aspects described may be implemented at the level of the virtual server or client.

With this in mind FIG. 2 is a simplified block diagram of a processor-based system (e.g., a computer system) 160 that can be used to implement the technology disclosed. Such a computer system typically includes at least one processor (e.g., microprocessor or CPU) 164 that communicates with a number of peripheral devices via bus subsystem 168. These peripheral devices can include a storage subsystem 172 including, for example, memory devices 176 (e.g., RAM 180 and ROM 184) and a file storage subsystem 188, user interface input devices 192, user interface output devices 196, and a network interface subsystem 198. The input and output devices allow user interaction with computer system (e.g., processing/storage system 160). Network interface subsystem 198 provides an interface to outside networks, including an interface to corresponding interface devices in other computer systems.

In the context of the depicted processor-based system 160, the user interface input devices 192 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” may be construed as encompassing all possible types of devices and ways to input information into computer system.

User interface output devices 196 can include a display subsystem, a printer, a fax machine, or non-visual displays such as audio output devices. The display subsystem can include a cathode ray tube (CRT), a flat-panel device such as a liquid crystal display (LCD) or organic light emitting diode (OLED) display, a projection device, or some other mechanism for creating a visible image. The display subsystem can also provide a non-visual display such as audio output devices. In general, use of the term “output device” may be construed as encompassing all possible types of devices and ways to output information from computer system to the user or to another machine or computer system.

Storage subsystem 172 stores programming and data constructs that provide the functionality of some or all of the modules and methods described herein, such as one or more of the annotation extraction engine 102, medical ontologies, 108, biomedical datastores 110, insurance codes 112, clinical codes 114, store catalogs or inventories, product listings, contact lists, and so forth. Stored software modules are generally executed by a processor 164 alone or in combination with other processors 164. Data constructs or tables may be stored locally on the processor-based system 160 or accessed from a remote system on which that are stored in such a storage subsystem.

Memory 176 used in the storage subsystem 172 can include a number of memory structures or devices, such as a main random-access memory (RAM) 180 for storage of instructions and data during program execution and a read only memory (ROM) 184 in which fixed instructions are stored. A file storage subsystem 188 can provide persistent storage for program and data files, and can include a hard disk drive, solid state data drives. a floppy disk drive along with associated removable media, a CD-ROM drive, an optical drive, or removable media cartridges. The modules implementing the functionality of certain implementations can be stored by file storage subsystem 188 in the storage subsystem 172, or in other machines accessible by the processor 164.

Bus subsystem 168 provides a mechanism for letting the various components and subsystems of computer system communicate with each other as intended. Although bus subsystem 168 is shown schematically as a single bus, alternative implementations of the bus subsystem 168 can use multiple busses.

The processor-based system 160 itself can be of varying types including a personal computer, a portable computer, a workstation, a computer terminal, a network computer, a thin client, a mainframe, a stand-alone server, a server farm, a widely-distributed set of loosely networked computers, or any other data processing system or user device. Due to the ever-changing nature of computers and networks, the description of a processor-based system 160 as depicted in FIG. 2 is intended only as an example for purposes of illustrating the functionality and types of components associated with the technology disclosed. Many other configurations of computer system are possible having more or less components or different components than the computer system depicted in FIG. 2.

With the preceding context in mind, the techniques discussed herein may be employed for processing free text data, including text data that is grammar-poor (such as text data derived from dictation or note taking and in which commas, periods, or grammar may be absent, poorly implemented, or poorly conveyed). Such processing may allow identification or derivation of annotations (e.g., phenotypes, diagnostic markers or descriptions, and so forth) from the processed text (e.g., clinician written or described notes) which may be useful in relating the content of the text to one or more ontological models and/or to associate the derived annotations with codes or labels that may be employed in downstream processes or analysis. In this manner, a grammar-poor and/or unstructured text passage may be processed to derive annotations that may be useful in analyzing or organizing the data.

By way of providing a real-world context, certain examples employed herein may relate to the processing of free-text notes or transcribed dictation, such as may be associated with a clinical examination or interview of a patient or of spoken communications to a virtual assistance in a household context. Such notes may be free-text (e.g., not limited to set or defined text options within designated fields or spaces), may be stream of thought or consciousness, and may be poorly punctuated or otherwise grammar-poor (such as not having appropriate commas, periods, or capitalization). Further, such notes may not be organized in conventional sentences or paragraphs, instead comprising listing of observations or symptoms, including acronyms and/or abbreviated descriptions or lingo specific to the clinician or their institution. As discussed herein, the presently disclosed techniques may be useful in such contexts, as well as other free-text contexts, for extracting annotations, such as phenotypes, that may be used in finding matched within different medical ontologies and/or in assigning clinical or insurance codes.

Indeed, the presently disclosed techniques may differ from conventional approaches, which may be optimized for processing structured text fields or data and/or to process complete sentences having appropriate punctuation (i.e., grammar-rich texts). In particular, in the context of free-text processing (including transcribed and/or grammar-poor contexts) conventional AI-based approaches may perform poorly in terms of faulty or erroneous AI annotation, no or incomplete linkage to specific ontologies (e.g., medical ontologies) of interest, overlap of annotations (e.g., phenotypes), lack of customizability, lack of gene annotation, failure to identify or translate abbreviations, non-orthogonal annotation, and so forth. More generally, AI-models may be trained to parse based on training data that is grammatical (e.g., has proper punctuation). With this in mind, in certain examples a lack of commas or regular punctuation in transcribed or otherwise informal notes, depending on the AI training data employed, may result in poor noun phrase parsing results during processing, which in turn may affect subset parsing.

As discussed herein, the presently disclosed techniques improve the extraction of annotations (e.g., phenotype annotations, clinical descriptions, anatomic or physiologic references or observations, and so forth) from free-text source materials, including grammar-poor source materials (e.g., transcribed notes, clinical interview or observation notes, and so forth). In particular, the presently disclosed techniques may be used to address the identification of phenotypes (or other suitable labels or annotations) in free-text as well as the resolution of overlapping phenotypes that may be derived or identified in such materials as part of the identification process. In addition, the presently disclosed techniques may allow for the inclusion or selection of only the desired ontologies (e.g., MONDO, HPO, OMIM, MeSH, and so forth) and/or the exclusion of undesired ontological terms as well as the annotation of genes (e.g., NCBI and/or HGNC genes). Correspondingly, the techniques developed and disclosed herein perform well in grammar-rich (e.g., abstracts) and grammar-poor (e.g., transcribed notes) contexts, perform well at parsing respective terms in a given text and linking such terms to ontological codes, and address issues related to overlap of identified or parsed terminology in a given passage, even in a grammar-poor environment.

With the preceding in mind, a trie data structure is employed for processing and parsing a text passage. As used herein, a “trie” or “trie data structure” may be understood to be an ordered (e.g., sequential or pseudo-sequential) tree data structure that is used to store an associative array or dynamic set and in which the keys may be characters (e.g., letters) or strings (e.g., words, phrases, and so forth). Likewise, a “noun phrase” as used herein may be understood to be a word or group of words that functions in a sentence as subject or object.

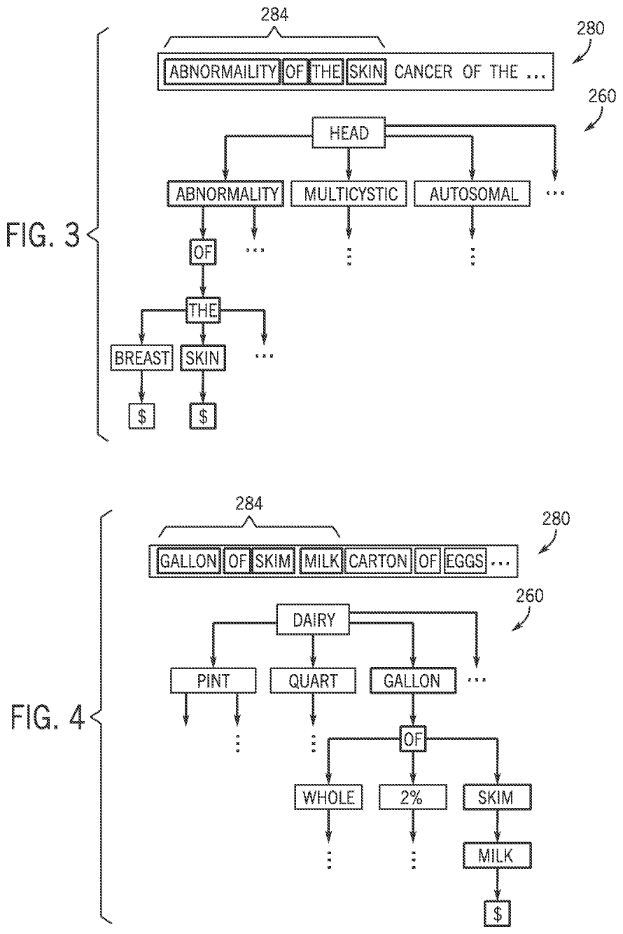

By way of example, and turning to FIG. 3, an example of a trie data structure 260 is depicted for a portion of a medical ontology which may be employed to parse or match a noun phrase 284 present in a text passage 280. By way of example, a depicted noun phrase 284 (“abnormality of the skin”) is provided to help illustrate the manner in which the trie 260 for the example ontology may be navigated to match the noun phrase 284 and relevant portion of the trie 260. The search or comparison of the passage 280 in question with respect to the trie 260 may be started at each word of the passage 280 and may proceed until a terminator (here represented as a “$” is reached in the trie 260. That is, each word in the passage 280 may be used as a starting point for comparison against the trie 260. The resulting match(es) may be used to establish or confirm the identified noun phrases 284 and/or to determine a label or annotation (e.g., a phenotype, clinical code, insurance code, and so forth) based on the ontological matches. In practice, the text passage 280 having the possible noun phrases 284 may be compared against one or more than one ontology (i.e., ontology trie 260), each ontology corresponding to a different organization, data store, lexicon, and so forth. In this manner, relevance of different ontologies may be assessed for a respective text passage 280 based on the number or quality of matches and or the relevance of the annotations derived using the respective ontology.

To illustrate the present concepts in the context of a non-biomedical text passage 280, a similar example provided in FIG. 4 corresponds to passages or items that may be provided as part of a grammar-poor text string conveying items to be included in a grocery list. By way of example, such a text passage 280 may be generated based on spoken communications with a virtual assistant or similar processor-implemented construct, which may generate (e.g., transcribe) the text passage 280 from the spoken communications. As shown in this non-biomedical example, noun phrases 284 (e.g., “gallon of skim milk”) may be parsed from the passage 280 using the trie 260 so as to delineate items in a list (e.g., a shopping list). In similar contexts, a task or to-do list or a list of contacts to be sent an e-mail or text message may be similarly parsed for those respective purposes. Indeed, though certain of the examples herein are provided in a biomedical context, it should be appreciated that the present techniques may be employed in any suitable parsing of a text passage 280 to generate or identify relevant phrases or words (e.g., noun phrases 284) for further operations.

Turning back to the biomedical example of FIG. 3, it may be appreciated that intervening or additional words in the passage 280 being compared to the trie 260 may result in a match being missed (i.e., falling off the trie). By way of example, if the example passage 280 were altered to instead read “abnormality of the man's skin” (FIG. 3) or “gallon of skim cow's milk” (FIG. 4), the corresponding noun phrase 284 might be unmatched or only loosely matched to the trie 260. With this in mind, in certain embodiments the processor-implemented matching routines may provide for one, two, three, or more “skips” (i.e., k skips) of unmatched words to allow a phrase 284 undergoing matching to a trie 260 to remain on the trie 260 by skipping a word or words in the passage 280 that are not in the trie 260. With reference to the preceding examples, the word “man's” or “cow's” may be skipped so as to allow the same match to occur to the corresponding trie 260 as would occur in the prior example. In practice the skipped words may be adjacent or spaced out within the passage 280 being processed (e.g., “abnormality of the young man's skin” or “abnormality or irregularly of the man's skin”). By allowing skips, a noun phrase 284 that might otherwise be unmatched may be matched while limiting the number of available skips maintains the integrity (e.g., specificity) of the matching process by preventing or limiting extraneous or erroneous matches. With this in mind, in certain embodiments the number (k) of skips may be limited to one, two, three, or four or may be dynamically set or adjusted based on the length of the passage 280. Further, in certain embodiments restrictions may be placed on the type of word that may be skipped. For example, in certain implementations only adjectives may be skipped, only prepositions may be skipped, or both adjectives and prepositions may be skipped.

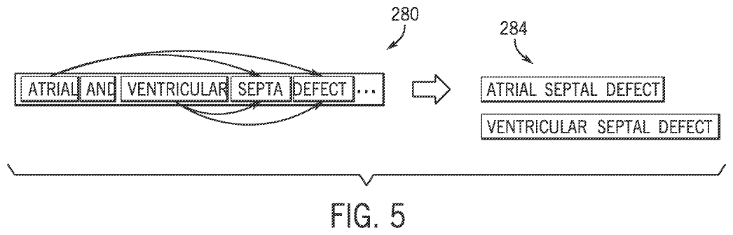

In certain implementations certain additional processing or parsing may be performed, such as to address conjunctions or negative limitations. By way of example, and turning to FIG. 5, in certain embodiments the use of skipping may result in a phenotype (or corresponding label in non-biomedical contexts) being missed or lost when a conjunction is present as such phenotypes will typically not be listed jointly in a trie. Thus, in the example depicted in FIG. 5, the passage “atrial and ventricular septal defect”, when processed using a trie and with two skips allowed (k=2) may only return the parsed phrase 284 of “atrial septal defect”, thus losing or missing the phrase “ventricular septal defect”. In accordance with certain embodiments, conjunctions (e.g., “and”, “or”, and so forth) function as keywords triggering additional processing. For example, as shown in FIG. 5, presence of a conjunction, here an “and”, may trigger separate processing for both words or terms separated by, and typically adjacent to, the “and” with respect to the following words. Hence, in this example the “and” may cause both “atrial” and “ventricular” to be separately processed using the trie and skipping approach and resulting in the phrases “atrial septal defect” and “ventricular septal defect” both being identified (i.e., parsed).

Additionally, in certain implementations negative modifiers or limitations may be separately identified and may trigger separate processing. By way of example, a clinician's transcribed notes may state that “no sinus congestion” was observed. As the modifier “no” is likely not present in an ontology trie, skipping the negative modifier will result in a “sinus congestion” phenotype being parsed from the passage. In such instance, it may be useful to process the initial passage normally using a trie 260 with skipping as discussed herein, resulting in the negative modifier being initially missed. However, subsequent to the initial parsing run, instances of such negative modifiers may be identified in the passage 180 and associated with the parsed phrase following the negative modifier in the passage 280 so as to retain the intended meaning. In such an example, the phrase “sinus congestion” may be initially parsed from the passage, subsequently the keyword “no” may be found to be present in the passage 280, and it may be associated with or added to the phrase 284 immediately following the negative modifier (i.e., “no sinus congestion) for the purpose of reporting or otherwise providing the extracted annotations.

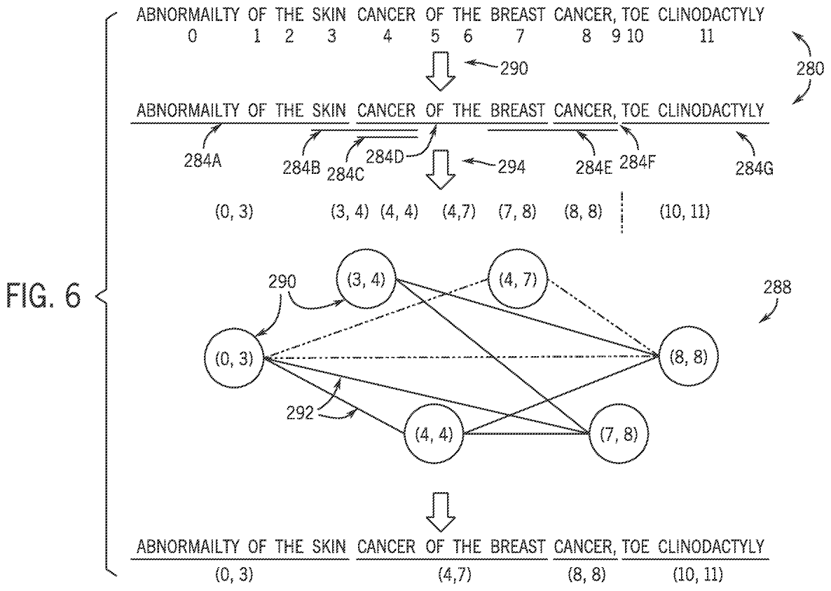

In practice, the use of word skipping to allow noun phrases that are being matched or parsed to remain on the trie 260 may lead to overlapping intervals between phrases identified as being on the trie 260. With this in mind, in certain implementations routines may be performed to minimize or eliminate such overlapping intervals (i.e., overlaps) between possible matching noun phrases present on the trie 260. An example of this is illustrated in FIG. 6, in which a passage 280 (“abnormality of the skin cancer of the breast cancer, toe clinodactyly”) is provided as an input to the annotation extraction process. As seen in FIG. 6, each word in the passage may be indexed or numbered (shown as index numbering under each word of the input passage 280) so as to facilitate subsequent overlap processing.

Subsequent to trie-based parsing (step 290) with skipping (k=2) as described above, numerous candidate noun phrases 284 are identified in the input passage 280. In the depicted examples, the candidate noun phrases (with associated intervals denoted parenthetically) include: phrase (0,3) 284A (i.e., “abnormality of the skin”), phrase (3,4) 284B (i.e., “skin cancer”), phrase (4,4), 284C (i.e., “cancer” (first instance)), phrase (4,7) 284D (i.e., “cancer of the breast”), phrase (7,8) 284E (i.e., “breast cancer”), phrase (8,8), 284F (i.e., “cancer” (second instance)), and phrase (10,11) 284G (i.e., “toe clinodactyly”). Of note, the input passage 280 include a single comma (denoted by index value 9), which is recognized as forming a break within the passage 280 and precludes overlap intervals spanning the comma. In such an example, the portions of the passage 180 on either side of the comma may be processed separately.

As may be appreciated upon review of this example, numerous of the candidate phrases 284 identified by trie-based parsing of the passage 280 with skipping overlap with one another. Indeed, phrases 284A, 284B, 284C, 284D, 284E, and 284F each overlap with at least one other candidate phrase. In accordance with the present techniques, the candidate phrases 284 may be processed (step 294) using overlapping intervals routines so as to minimize or eliminate intersections (i.e., overlaps) between candidate phrases while maximizing coverage of the passage 280 so as to reduce the likelihood that a word that is present in the passage 280 is disregarded. By way of example, in one embodiment intersections are set to zero (i.e., no overlaps) and coverage is maximized for this zero intersection set.

In one such example, the overlapping intervals routines 294 are implemented using a graph theory-based approach. By way of example, and with reference to FIG. 6, each parsing (i.e., phrase 284) and associated interval (e.g., (0,3), (3,4), (4,4), and so forth) found within a passage 280 is converted to a node 290 of the graph 288. Edges 292 are then added between nodes 290 if the respective intervals associated with those nodes do not overlap. Thus, the presence of an edge 292 is indicative that the two nodes connected by the respective edge do not overlap. Once nodes 290 and edges 292 are established, cliques are identified, where each clique corresponds to a set of nodes (possibly as few as one node) in which all nodes in the clique are fully connected, and therefore do not overlap. Once the cliques are identified, the clique providing maximal coverage of the passage 280 is determined, the phrases 284 corresponding to the nodes 290 of this clique are returned as the parsed phrases for the passage 280. In one embodiment, this approach may be implemented so as to allow no intersections (i.e., zero overlaps) while maximizing coverage. In the depicted example, candidate noun phrases (0,3) 284A (i.e., “abnormality of the skin”), phrase (4,7) 284D (i.e., “cancer of the breast”), phrase (8,8) 284F (i.e., “cancer”), and phrase (10,11) 284G (i.e., “toe clinodactyly”) are identified as the noun phrases 284 that eliminate intersections (i.e., overlaps) while maximizing coverage of the passage 280.

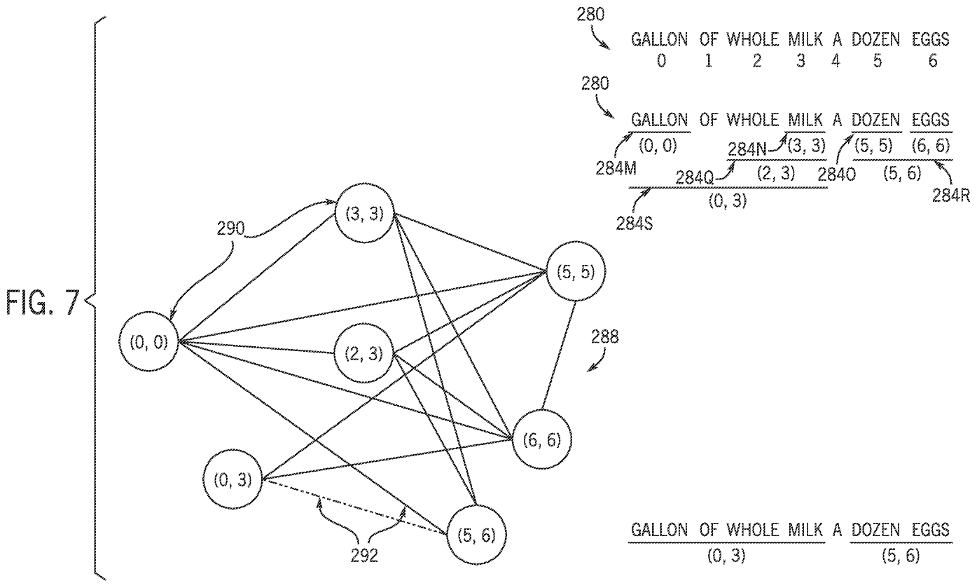

In a further, non-biomedical example illustrated in FIG. 7 (in a manner similar to FIG. 6) a passage 280 that might be associated with a grocery or shopping list is illustrated. As in the preceding example, numerous candidate noun phrases 284 are identified in the input passage 280. In the depicted examples, the candidate noun phrases (with associated intervals denoted parenthetically) include: phrase (0,0) 284M (i.e., “gallon”), phrase (3,3) 284N (i.e., “milk”), phrase (5,5), 284O (i.e., “dozen”), phrase (6,6) 284P (i.e., “eggs”), phrase (2,3) 284Q (i.e., “whole milk”), phrase (5,6), 284R (i.e., “dozen eggs”), and phrase (0,3) 284S (i.e., “gallon of whole milk”). As described in the preceding example of the operation of an overlapping intervals routine, each parsing (i.e., phrase 284) and associated interval found within the passage 280 is converted to a node 290 of the graph 288 and edges 292 are added between nodes 290 if the respective intervals associated with those nodes do not overlap. Cliques are identified that correspond to sets of nodes in which all nodes in the clique are fully connected and do not overlap. Once the cliques are identified, the clique providing maximal coverage of the passage 280 is determined, the phrases 284 corresponding to the nodes 290 of this clique are returned as the parsed phrases (e.g., items for a shopping list) for the passage 280. In one embodiment, this approach is implemented so as to allow no intersections while maximizing coverage. In the depicted example, candidate noun phrases (0,3) 284S (i.e., “gallon of whole milk”) and phrase (5,6) 284R (i.e., “dozen eggs”) are identified as the noun phrases 284 that eliminate intersections (i.e., overlaps) while maximizing coverage of the passage 280.

In addition to the aspects of trie-based annotation extraction process described in the preceding discussion and examples, one or more additional features may be incorporated into such a technique in a real-world implementation.

By way of example, in certain embodiments a spelling correction step or subroutine may be performed on the input passage 280 prior to processing. Such an approach may utilize or leverage spelling correction or suggestion routines to process words within the passage 280 (either analyzed alone or in the context provided by neighboring words) to change or correct the spelling of words automatically identified as misspelled (e.g., “cronic” to “chronic”, “obessity” to “obesity” and so forth).

Similarly, a lemmatization step or subroutine may be performed on words within the passage 280. As used herein, lemmatization refers to standardizing different forms or inflections of a word so as to allow analysis of a single term or version of the word (e.g., the root word). In practice this may involve cleaving suffixes from words in a plural, past tense, future tense, gerund form and so forth so as to allow analysis of the different variations of a word a single time. For example, “difficulties” may be changed to “difficulty”, “delays” to “delay” and so forth. In addition to terms or words found in the passage 280, the various ontologies used for comparison may also undergo lemmatization.

In addition, an acronym subroutine may be performed as part of processing the passage 280. When performed, such a subroutine may substitute the full terminology for an identified acronym present in the passage 280 so as to remove all identified acronyms and standardize the terminology within the passage. For example, if the acronym “BC” is present in the passage 280 and identified as being a substitute for the phrase “breast cancer”, the phrase “breast cancer” may be substituted in the passage 280 for all instances of the acronym “BC”. In this manner, inconsistent usage of acronyms (or other short-hand terminology) and the full terminology may be standardized to one format. In one embodiment in which the subroutines described above are implemented, they may be implemented sequentially such that spelling errors are corrected first, acronyms are replaced next, and lemmatization performed last. Subsequent to these steps or subroutines, parsing the passage using the trie-based techniques and overlap optimization described herein may be performed.

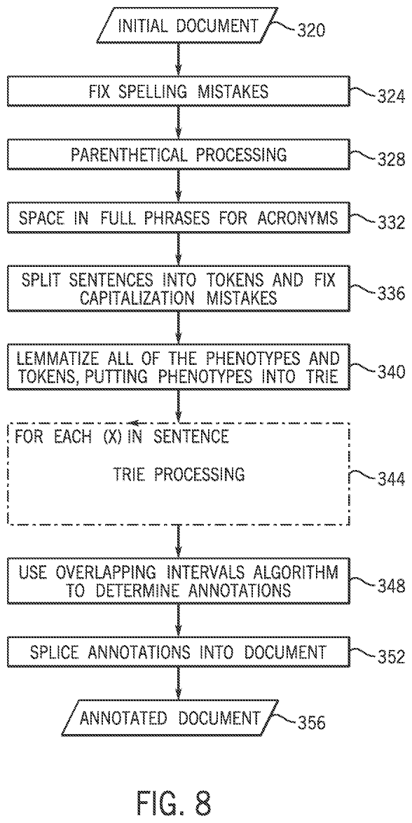

Turning to FIG. 8, the preceding concepts and techniques are illustrated in an example workflow that may be suitable for extracting biomedical, genomic, or other annotations from an initial document 320, such as a digital free-text document based on or generated for clinical notes or transcribed dictation. Such annotations, as described herein, may be linked to or otherwise used to determine relevant codes, such as insurance or clinical codes, that may form part of a patient's electronic medical record or may be used as part of the clinical or administrative handling of the patient. As also discussed, however, in a more general sense the described workflow may be suitable for processing non-biomedical texts as well to derive labels, items, contacts, and so forth that may be useful for a downstream operation (e.g., constructing a shopping list, specifying recipients of an e-mail or text, and so forth.

As shown in FIG. 8, the initial document 320 may be processed to fix spelling mistakes (step 324) detected within the document 320, such as using one or more spelling correction sub-routines. In the depicted example, a subroutine may then be executed to address parentheticals present in the document 320. By way of example, such parenthetical processing may determine whether material in parenthesis relates to previous words in the document 320, abbreviations, non-alphabetic characters, acronyms, genes, diseases, and so forth, and may remove or replace such parenthetical material appropriately such that this material is presented in a consistent manner within the document 320.

In the depicted example implementation, and subsequent to the parenthetical processing of the document at block 328, acronyms may be removed and replaced with the full phrases or text represented by the acronym(s) (step 332). In a further step, sentences or passages may be split into tokens for further processing and capitalization errors, if present, may be fixed (step 336). Phenotypes and tokens may then be lemmatized and the phenotypes organized, or otherwise placed, processed as or against a trie (step 340), as discussed herein.

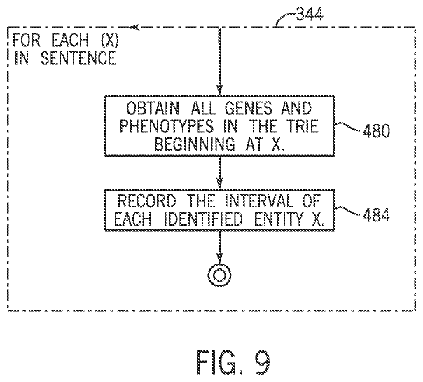

Turning to FIG. 9, processing of the trie (step 344 of FIG. 8) is shown in greater detail. In the processing loop illustrated in the example of FIG. 9, all genes and phenotypes in a trie (in the present biomedical or genetic context) are obtained (step 480) by sequentially walking through the trie. As noted herein, obtaining the genes or phenotypes within the trie may involve allowing a limited number (e.g., 1, 2, 3, 4, 5 and so forth) of skips to bypass words not present in the trie so as to avoid inadvertently falling off the trie. For each entity (phenotype or gene or, more generally, noun phrases) so identified, a corresponding interval (e.g., (0,3), (4,5), and so forth) is recorded or otherwise determined (step 484).

Turning back to FIG. 8, the determined intervals may be processed (step 348) using the overlapping intervals subroutine described herein to determine annotations in the document 320. As discussed herein, the overlapping intervals processing involves minimizing (e.g., eliminating) overlaps or intersections while maximizing coverage of a given passage within the document 320. Annotations so obtained may be spliced (step 352) into the document 320 so as to generate an annotated document 356. In practice, as discussed herein, the annotations may be used to link to specialized ontologies (e.g., medical or genetic ontologies), insurance or billing codes, and/or clinical or diagnostic codes.

With the preceding discussion and explanation in mind, cumulative performance of the present techniques (e.g., trie processing with skips (k=2) plus overlap interval processing) was assessed on 20 clinical summaries (i.e., free-text, grammar poor documents (i.e., no punctuation)). The phenotype true positive performance was assessed to be 186.5 (versus 165.5 for a naïve trie approach); the phenotype false positive performance was assessed to be 8 (versus 20 for a naïve trie approach); and the phenotype false negative performance was assessed to be 57.5 (versus 78.5 for a naïve trie approach). Thus, in this study the results using the presently described techniques were superior to those obtained for a naïve trie approach for all of true positives, false positives, and false negatives.

This written description uses examples, including the best mode, and also to enable any person skilled in the art to practice the disclosed embodiments, including making and using any devices or systems and performing any incorporated methods. Such other examples are intended to be within the scope of the claims if they have structural elements that do not differ from the literal language of the claims, or if they include equivalent structural elements with insubstantial differences from the literal languages of the claims.

What is claimed is:

1. A method for processing a text input, comprising:
receiving as an input a text string comprising a plurality of discrete words;
processing the text string using a trie corresponding to one or more ontologies of interest, wherein a number of skips are defined for processing the trie so that deviations of the words within the text string up to the number of skips are allowed during processing, wherein an output of processing the text string using the trie comprises a plurality of phrases;
processing the output to determine a set of phrases that both minimize or limit a number of overlaps between the phrases and maximize coverage of the text string;
associating each phrase of the set of phrases with a respective ontology code; and
outputting the respective ontology codes for review.

2. The method of claim 1, wherein the text input comprises one or both of notes or transcribed dictation.

3. The method of claim 1, wherein the text string comprises no punctuation or insufficient punctuation to convey separation of one or more phrases within the text string.

4. The method of claim 1, wherein the trie comprises a trie of biomedical or genetic terminology.

5. The method of claim 1, wherein the number of skips comprises one, two, three, or four skips.

6. The method of claim 1, wherein the output of processing the text string using the trie comprises the plurality of phrases and a respective interval for each phrase of the plurality.

7. The method of claim 1, wherein processing the output to determine the set of phrases limits the number of overlaps to zero.

8. The method of claim 1, wherein processing the output to determine the set of phrases comprises:
generating a graph comprising a node for each phrase, wherein each node has an associated interval determined based on the respective phrase for the node;
connecting each pair of nodes that do not intersect with an edge;
determining a clique having maximal coverage of the text string based on the nodes and edges.

9. The method of claim 1, wherein the deviations of the words within the text string up to the number of skips that are allowed during processing are limited to skipping one of adjectives, prepositions, or adjectives and prepositions.

10. The method of claim 1, wherein processing the text string using the trie further comprises separately processing words adjacent to a conjunction using the trie so as to generate a separate phrase for each word separated by the conjunction.

11. The method of claim 1, wherein processing the text string using the trie further comprises:
identifying a negative modifier within the text string;
subsequent to processing the text string using the trie, associating the negative modifier with a respective phrase derived from a portion of the text string following the negative modifier in the text string.

12. One or more tangible, machine-readable media storing processor-executable routines, wherein the processor-executable routines, when executed by a processor, cause acts to be performed comprising:
processing a text string using a trie, wherein a number of skips are defined for processing the trie so that deviations within the text string relative to the trie up to the number of skips are allowed without falling off the trie, wherein an output of processing the text string using the trie comprises a plurality of phrases each having a respective interval;
generating a graph based on the output, wherein the graph comprises:
a respective node for each phrase and associated interval;
a respective edge between each pair of non-intersecting nodes;
determining a clique providing maximal coverage of the text string based on the graph; and
determining or outputting one or more phrases corresponding to the clique as parsed phrases for the text string.

13. The one or more tangible, machine-readable media of claim 12, wherein the processor-executable routines, when executed by the processor, cause further acts to be performed comprising:
associating each phrase of the one or more phrases determined for the clique with a respective ontology code; and
outputting the respective ontology codes for review.

14. The one or more tangible, machine-readable media of claim 12, wherein the text string comprises no punctuation or insufficient punctuation to convey separation of one or more phrases within the text string.

15. The one or more tangible, machine-readable media of claim 12, wherein the number of skips comprises one, two, three, or four skips.

16. The one or more tangible, machine-readable media of claim 12, wherein the number of skips that are allowed during processing of the text string are limited to skipping one of adjectives, prepositions, or adjectives and prepositions.

17. A method for selecting a subset of phrases from among a plurality of phrases, comprising:
generating a graph comprising:
a respective node for each phrase of the plurality of phrases, wherein each node has a corresponding interval based on the phrase corresponding to the respective node;
a respective edge between each pair of non-intersecting nodes; and
one or more cliques, wherein each clique corresponds to one or more inter-connected and non-overlapping nodes;
determining a respective clique of the one or more cliques that provides maximal coverage of a text string comprising the plurality of phrases; and
outputting a respective code corresponding to each node of the respective clique, wherein each node of the respective clique is associated with a respective phrase of the plurality of phrases.

18. The method of claim 17, further comprising:
prior to generating the graph, processing the text string using a trie to generate the plurality of phrases.

19. The method of claim 18, wherein processing the text string using the trie comprises allowing a limited number of skips of words in the text string to avoid falling off the trie.

20. The method of claim 17, wherein the text string comprises no punctuation or insufficient punctuation to convey separation of one or more phrases within the text string.
